(19) United States
(12) Patent Application Publication
(10) Pub. No.: US 2024/0046292 A1
(43) Pub. Date: Feb. 8, 2024

(54) INTELLIGENT PREDICTION OF LEAD CONVERSION

(71) Applicant: Dell Products L.P., Round Rock, TX (US)

(72) Inventors: Manoj Nambirajan, Hyderabad (IN); Bijan Kumar Mohanty, Austin, TX (US); Mohit Kumar Agarwal, Karnataka (IN); Hung Dinh, Austin, TX (US)

(73) Assignee: Dell Products L.P., Round Rock, TX (US)

(21) Appl. No.: 17/817,451

(22) Filed: Aug. 4, 2022

(51) Int. Cl. G06Q 30/02; G06N 20/20

(52) U.S. Cl. CPC G06Q 30/0205; G06Q 30/0201; G06N 20/20

(57) ABSTRACT

In one aspect, an example methodology implementing the disclosed techniques includes, by a computing device, receiving information regarding a new lead from another computing device and determining one or more relevant features from the information regarding the new lead, the one or more relevant features influencing prediction of a lead conversion. The method also includes, by the computing device, generating, using a machine learning (ML) model, a prediction of a likelihood of the new lead converting to a sales opportunity based on the determined one or more relevant features based on the determined one or more relevant features and sending the prediction to the another computing device.

### BACKGROUND

Organizations, such as companies, enterprises, and manufacturers, continually grapple with having to determine whether a lead will ever be converted into a sales opportunity. A lead may be a potential customer, such as an individual, a contact, or a company, that has been identified as having an interest in a product or service offered by the organization. Leads may be generated in various ways, such as via referrals, marketing, social media, networking, product trials, or consultations. When a lead is qualified by the organization it is converted into a sales opportunity. Sales opportunities are essentially “deals in progress” and are processed by the organization to closure (e.g., either a winning deal or a losing deal).

Organizations need to evaluate leads to determine which leads to prioritize. For example, a marketing and/or sales team within an organization typically determines which leads to pursue in hopes of converting the leads to sales opportunities. However, existing marketing/sales processes, including the plethora of sales and marketing tools that are available to the marketing/sales team, fail to provide any insights on the conversion of a lead into a sales opportunity. In the absence of this insight, the marketing/sales team initially places equal priority to all the leads and is unable to focus their efforts on the leads that are more likely to be converted. This results in low conversion rates which is out-of-line with the organization's business goals and objectives. This situation is compounded when there is a large volume of leads which need to be evaluated.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving information regarding a new lead from another computing device and determining one or more relevant features from the information regarding the new lead, the one or more relevant features influencing prediction of a lead conversion. The method also includes, by the computing device, generating, using a machine learning (ML) model, a prediction of a likelihood of the new lead converting to a sales opportunity based on the determined one or more relevant features based on the determined one or more relevant features and sending the prediction to the another computing device.

In some embodiments, the ML model includes an ML classification model. In one aspect, the ML classification model includes a plurality of classifiers. In another aspect, the ML classification model includes a random forest.

In some embodiments, the ML model is generated using a modeling dataset generated from a corpus of historical lead conversion data of an organization.

In some embodiments, the one or more relevant features includes a feature indicative of a customer associated with the new lead.

In some embodiments, the one or more relevant features includes a feature indicative of an individual responsible for the new lead.

In some embodiments, the one or more relevant features includes a feature indicative of a geographic region associated with the new lead.

In some embodiments, the one or more relevant features includes a feature indicative of a source that generated the new lead.

In some embodiments, the one or more relevant features includes a feature indicative of a product focus associated with the new lead.

In some embodiments, the information regarding the new lead is received from a remote computing device, and the sending the prediction is to the remote computing device.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A is a block diagram of an illustrative network environment for intelligent lead conversion prediction, in accordance with an embodiment of the present disclosure.

FIG. 1B is a block diagram of an illustrative lead conversion service, in accordance with an embodiment of the present disclosure.

FIG. 2 is a diagram illustrating a portion of a data structure that can be used to store information about relevant features of a modeling dataset for training a machine learning (ML) model to predict a likelihood of a lead conversion, in accordance with an embodiment of the present disclosure.

FIG. 3 is a diagram showing an example topology that can be used to predict a likelihood of a lead conversion, in accordance with an embodiment of the present disclosure.

FIG. 4 is a flow diagram of an example process for prediction of a likelihood of a lead conversion, in accordance with an embodiment of the present disclosure.

FIG. 5 is a block diagram illustrating selective components of an example computing device in which various aspects of the disclosure may be implemented, in accordance with an embodiment of the present disclosure.

### DETAILED DESCRIPTION

Certain embodiments of the concepts, techniques, and structures disclosed herein are directed to an artificial intelligence (AI)/machine learning (ML)-powered framework for predicting whether a lead will convert to a sales opportunity. The lead may belong to or otherwise be associated with an organization such as a company or other enterprise. In some embodiments, the prediction (i.e., a likelihood of a lead conversion) can be achieved using an ML classification model generated from one or more ML algorithms trained using a modeling dataset. For example, in some such embodiments, a decision tree-based algorithm, such as a random forest, may be trained using a modeling dataset generated from the organization's multi-dimensional historical lead conversion data. The historical lead conversion data includes historical lead data (e.g., historical lead information) and corresponding conversion data which indicates whether the historical leads converted to sales opportunities. The historical lead conversion data may be modeled and viewed in multiple dimensions (e.g., the historical lead conversion data may be viewed in the form of a data cube). In embodiments, the historical lead conversion data is a dataset with a large number of different features (or “attributes”). Such features may include insights and datapoints about the organization's historical (or “past”) leads and the strategies and processes undertaken by the organization (e.g., the marketing team) to qualify the past leads. For example, for a given historical lead, the lead conversion data may include information about the customer, business segment, product, region, language, and time period, among others. The historical lead conversion data may be collected from the organization's sales and marketing systems and various other sources. The resulting ML classification model (e.g., the trained random forest) can, in response to input of a new lead (e.g., input of information about the organization's new lead), predict whether the new lead will convert to a sales opportunity. In other words, the trained ML classification model can predict a likelihood of the new lead converting to a sales opportunity. The organization (e.g., management) can then decide whether to pursue the new lead. Prediction of lead conversion based on historical lead conversion insights and datapoints can help the organization deploy the marketing team to focus on the new leads that have better potential, which contributes to increase sales for its products or services.

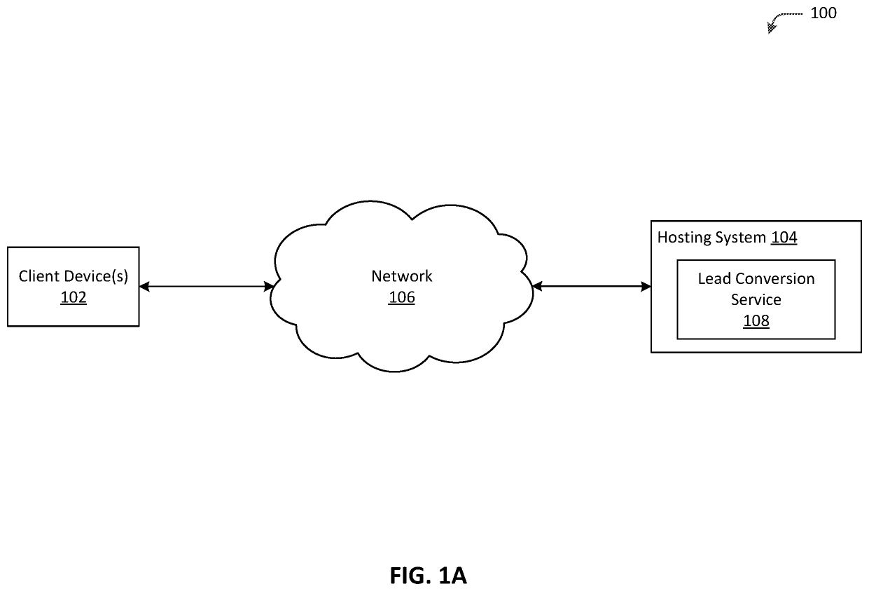

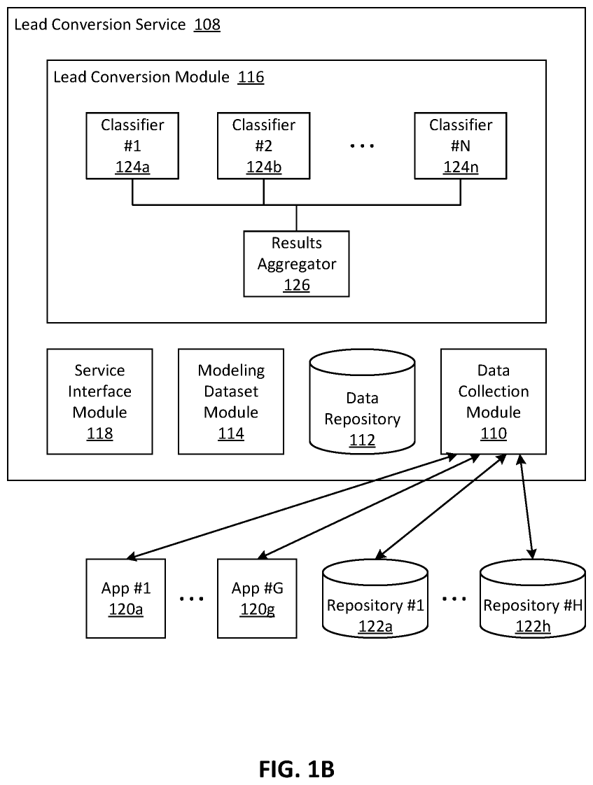

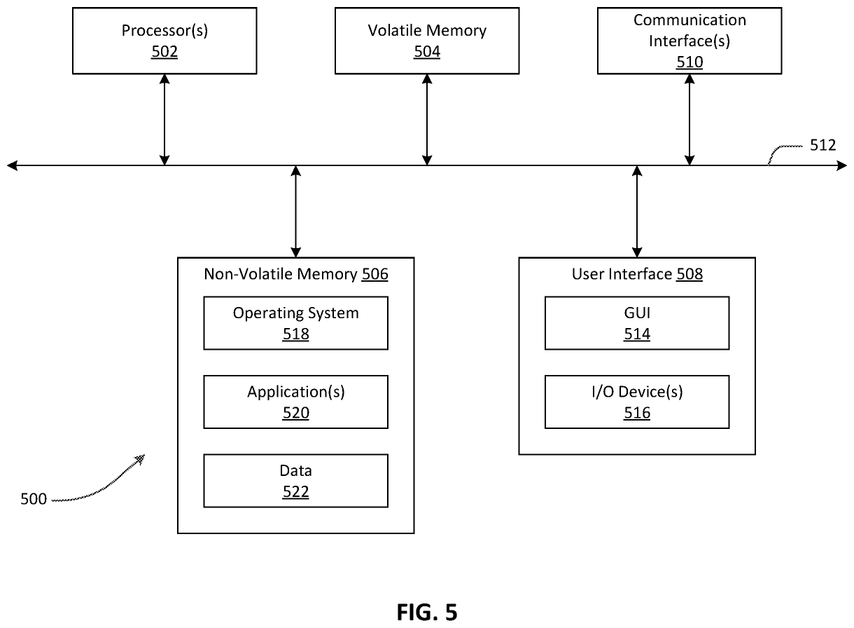

Turning now to the figures, FIG. 1A is a block diagram of an illustrative network environment 100 for intelligent lead conversion prediction, in accordance with an embodiment of the present disclosure. As illustrated, network environment 100 may include one or more client devices 102 communicatively coupled to a hosting system 104 via a network 106. Client devices 102 can include smartphones, tablet computers, laptop computers, desktop computers, workstations, or other computing devices configured to run user applications (or “apps”). In some implementations, client devices 102 may be substantially similar to a computing device 500, which is further described below with respect to FIG. 5.

Hosting system 104 can include one or more computing devices that are configured to host and/or manage applications and/or services. Hosting system 104 may include load balancers, frontend servers, backend servers, authentication servers, and/or any other suitable type of computing device. For instance, hosting system 104 may include one or more computing devices that are substantially similar to computing device 500, which is further described below with respect to FIG. 5.

In some embodiments, hosting system 104 can be provided within a cloud computing environment, which may also be referred to as a cloud, cloud environment, cloud computing or cloud network. The cloud computing environment can provide the delivery of shared computing services (e.g., microservices) and/or resources to multiple users or tenants. For example, the shared resources and services can include, but are not limited to, networks, network bandwidth, servers, processing, memory, storage, applications, virtual machines, databases, software, hardware, analytics, and intelligence.

As shown in FIG. 1A, hosting system 104 may include a lead conversion service 108. As described in further detail at least with respect to FIGS. 1B-4, lead conversion service 108 is generally configured to predict a likelihood of a lead conversion using an ML model (e.g., an ML classification model). The prediction of a probability of conversion into a sales opportunity may be for a new lead of the organization. Briefly, in one example use case, a user associated with the organization, such as a member of the organization's marketing team, can use a client application, such as a web client, on their client device 102 to access lead conversion service 108. For example, the client application may provide user interface (UI) controls that the user can click/tap/interact with to access lead conversion service 108 and issue a request for a lead conversion determination (e.g., send a request to determine whether a lead (e.g., a new lead) will convert to a sales opportunity). The client application may also provide UI elements (e.g., a lead details form) with which the user can specify details about the lead for which the lead conversion determination is being requested. In response to such request being received, lead conversion service 108 can predict a likelihood of the lead converting to a sales opportunity and send an indication of the prediction in a response to the client application. In response to receiving the response, the client application can present the response (e.g., the indicated prediction) within a UI (e.g., a graphical user interface) for viewing by the user. The user can then take appropriate action based on the provided prediction. For example, the user may prioritize the lead for assignment to a marketing associate.

FIG. 1B is a block diagram of an illustrative lead conversion service 108, in accordance with an embodiment of the present disclosure. For example, an organization such as a company, an enterprise, or other entity that sells or otherwise provides products and/or services, for instance, may implement and use lead conversion service 108 to intelligently predict a likelihood of a lead conversion (i.e., likelihood of a lead converting to a sales opportunity). Lead conversion service 108 can be implemented as computer instructions executable to perform the corresponding functions disclosed herein. Lead conversion service 108 can be logically and/or physically organized into one or more components. The various components of lead conversion service 108 can communicate or otherwise interact utilizing application program interfaces (APIs), such as, for example, a Representational State Transfer (RESTful) API, a Hypertext Transfer Protocol (HTTP) API, or another suitable API, including combinations thereof.

In the example of FIG. 1B, lead conversion service 108 includes a data collection module 110, a data repository 112, a modeling dataset module 114, a lead conversion module 116, and a service interface module 118. Lead conversion service 108 can include various other components (e.g., software and/or hardware components) which, for the sake of clarity, are not shown in FIG. 1B. It is also appreciated that lead conversion service 108 may not include certain of the components depicted in FIG. 1B. For example, in certain embodiments, lead conversion service 108 may not include one or more of the components illustrated in FIG. 1B (e.g., modeling dataset module 114), but lead conversion service 108 may connect or otherwise couple to the one or more components via a communication interface. Thus, it should be appreciated that numerous configurations of lead conversion service 108 can be implemented and the present disclosure is not intended to be limited to any particular one. That is, the degree of integration and distribution of the functional component(s) provided herein can vary greatly from one embodiment to the next, as will be appreciated in light of this disclosure.

Referring to lead conversion service 108, data collection module 110 is operable to collect or otherwise retrieve the organization's historical lead conversion data from one or more from one or more data sources. The data sources can include, for example, one or more applications 120a-120g (individually referred to herein as application 120 or collectively referred to herein as applications 120) and one or more repositories 122a-122h (individually referred to herein as repository 122 or collectively referred to herein as repositories 122). Applications 120 can include various types of applications such as software as a service (SaaS) applications, web applications, and desktop applications, to provide a few examples. In some embodiments, applications 120 may correspond to the organization's marketing applications and sales applications such as a horizontal marketing system, a vertical marketing system, a hybrid marketing system, and/or a sales customer relationship management (CRM) system. Repositories 122 can include various types of data repositories such as conventional file systems, cloud-based storage services such as SHAREFILE, BITBUCKET, DROPBOX, and MICROSOFT ONEDRIVE, and web servers that host files, documents, and other materials. In some embodiments, repositories 122 may correspond to the organization's repositories used for storing at least some of the historical lead conversion data.

Data collection module 110 can utilize application programming interfaces (APIs) provided by the various data sources to collect information and materials therefrom. For example, data collection module 110 can use a REST-based API or other suitable API provided by a marketing application/system or sales application/system to collect information therefrom (e.g., to collect the historical lead conversion data). In the case of web-based applications, data collection module 110 can use a Web API provided by a web application to collect information therefrom. As another example, data collection module 110 can use a file system interface to retrieve the files containing historical lead conversion data and related information, etc., from a file system. As yet another example, data collection module 110 can use an API to collect documents containing historical lead conversion data and related information, etc., from a cloud-based storage service. A particular data source (e.g., a marketing application/system, sales application/system, and/or data repository) can be hosted within a cloud computing environment (e.g., the cloud computing environment of lead conversion service 108 or a different cloud computing environment) or within an on-premises data center (e.g., an on-premises data center of an organization that utilizes lead conversion service 108).

In cases where an application or data repository does not provide an interface or API, other means, such as printing and/or imaging, may be utilized to collect information therefrom (e.g., generate an image of printed document containing information/data about a historical lead). Optical character recognition (OCR) technology can then be used to convert the image of the content to textual data.

As mentioned previously, data collection module 110 can collect the historical lead conversion data from one or more data sources. The historical lead conversion data includes historical lead data which includes insights and datapoints about the past leads and the strategies and processes undertaken to qualify the past leads. For a given historical lead, the historical lead conversion data can include conversion data which indicates whether the historical lead converted to a sales opportunity. Data collection module 110 can store the historical lead conversion data collected from the various data sources within data repository 112, where it can subsequently be retrieved and used. For example, the historical lead conversion data and other materials from data repository 112 can be retrieved and used to generate a modeling dataset for use in generating an ML model. In some embodiments, data repository 112 may correspond to a storage service within the computing environment of lead conversion service 108.

In some embodiments, data collection module 110 can collect the historical lead conversion data from one or more of the various data sources on a continuous or periodic basis (e.g., according to a predetermined schedule specified by the organization). For example, data collection module 110 can collect the historical lead conversion data for or associated with leads from the preceding six months, nine months, or another suitable period. The period for the historical leads whose conversion data is to be collected may be configurable by the organization. Additionally or alternatively, data collection module 110 can collect the historical lead conversion data from one or more of the various data sources in response to an input. For example, a user of lead conversion service 108 can use their client device 102 and issue a request to collect historical lead conversion data from one or more data sources. The request may indicate a period for the historical leads whose lead conversion data is to be collected. In response, data collection module 110 can collect the historical lead conversion data from the one or more data sources.

Modeling dataset module 114 is operable to generate (or “create”) a modeling dataset for use in generating (e.g., training, testing, etc.) an ML classification model to predict a likelihood of a lead conversion. Modeling dataset module 114 can retrieve from data repository 112 a corpus of historical lead conversion data from which to generate the modeling dataset. In one embodiment, one, two, or more years of historical lead conversion data can be retrieved from which to create the modeling dataset. The amount of historical lead conversion data to retrieve and use to create the modeling dataset may be configurable by the organization.

To generate a modeling dataset, modeling dataset module 114 may preprocess the retrieved corpus of historical lead conversion data to be in a form that is suitable for training and testing the ML classification model. In one embodiment, modeling dataset module 114 may utilize natural language processing (NLP) algorithms and techniques to preprocess the retrieved lead conversion data. For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stop words removal, stemming, and/or lemmatization.

The data preprocessing may also include placing the data into a tabular format. In the table, the structured columns represent the features (also called “variables”) and each row represents an observation or instance (e.g., a historical lead). Thus, each column in the table shows a different feature of the instance. The data preprocessing may also include placing the data (information) in the table into a format that is suitable for training a model (e.g., placing into a format that is suitable for a random forest algorithm or other suitable learning algorithm to learn from to generate (or “build”) the ML classification model). For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding or other suitable encoding methods.

The data preprocessing may also include null data handling (e.g., the handling of missing values in the table). According to one embodiment, null or missing values in a column (a feature) may be replaced by mean of the other values in that column. For example, mean imputation may be performed using a mean imputation technique such as that provided by Scikit-learn (Sklearn). According to alternative embodiments, observations in the table with null or missing values in a column may be replaced by a mode or median value of the values in that column or removed from the table.

The data preprocessing may also include feature selection and/or data engineering to determine or identify the relevant or important features from the noisy data. The relevant/important features are the features that are more correlated with the thing being predicted by the trained model (e.g., a likelihood of a lead conversion). A variety of feature engineering techniques, such as exploratory data analysis (EDA) and/or bivariate data analysis with multivariate-variate plots and/or correlation heatmaps and diagrams, among others, may be used to determine the relevant features. The relevant features are the features that are more correlated with the thing being predicted by the trained model. For example, for a particular historical lead, the relevant features may include important features from the lead data such as customer/account, lead contact, lead owner, lead source (e.g., partner/contact, web, unknown, etc.), campaign type, product focus, solution, region, and language, among others.

The data preprocessing can include adding an informative label to each instance in the modeling dataset. As explained above, each instance in the modeling dataset is a historical lead of the organization. A label (e.g., an indication of conversion to a sales opportunity) is added to each instance in the modeling dataset. The label added to each instance, i.e., each historical lead, is a representation of what class of objects the instance in the modeling dataset belongs to and helps a machine learning model learn to identify that particular class when encountered in data without a label. For example, for a given historical lead, the added label may indicate whether the historical lead was converted to a sales opportunity.

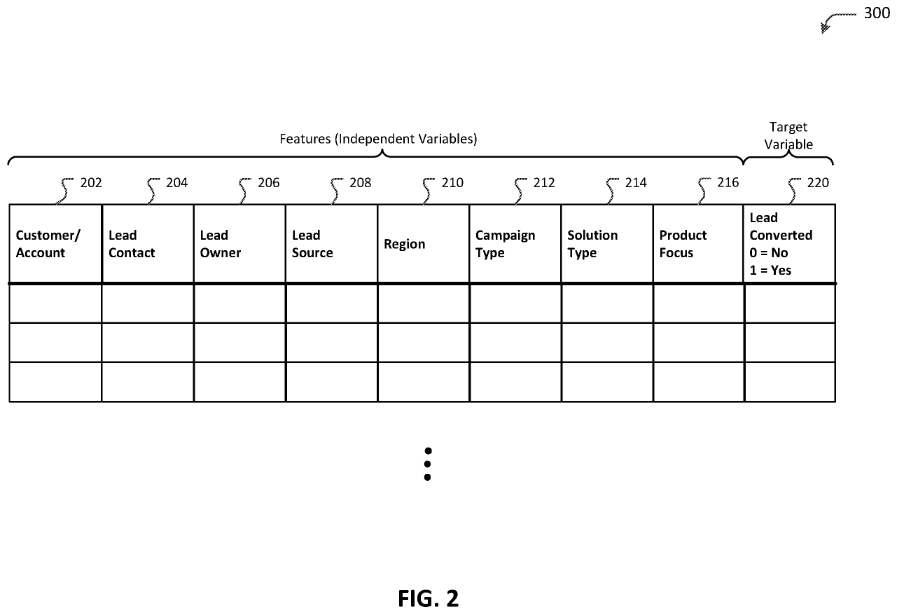

Each instance in the table may represent a training/testing sample (i.e., an instance of a training/testing sample) in the modeling dataset and each column may be a relevant feature of the training/testing sample. As previously described, each training/testing sample may correspond to a historical lead of the organization. In a training/testing sample, the relevant features are the independent variables and the thing being predicted (e.g., a likelihood of a lead conversion) is the dependent variable (e.g., label). In some embodiments, the individual training/testing samples may be used to generate a feature vector, which is a multi-dimensional vector of elements or components that represent the features in a training/testing sample. In such embodiments, the generated feature vectors may be used for training or testing the ML classification model using supervised learning to make a prediction. Examples of relevant features of a modeling dataset for training/testing the ML classification model for predicting a likelihood of a lead conversion is provided below with respect to FIG. 2.

In some embodiments, modeling dataset module 114 may reduce the number of features in the modeling dataset. For example, since the modeling dataset is being generated from the corpus of historical lead conversion data, the number of features (or input variables) in the dataset may be very large. The large number of input features can result in poor performance for machine learning algorithms. For example, in one embodiment, modeling dataset module 114 can utilize dimensionality reduction techniques, such as principal component analysis (PCA), to reduce the dimension of the modeling dataset (e.g., reduce the number of features in the dataset), hence improving the model's accuracy and performance.

In some embodiments, modeling dataset module 114 can generate the modeling dataset on a continuous or periodic basis (e.g., according to a predetermined schedule specified by the organization). For example, modeling dataset module 114 can generate the modeling dataset according to a preconfigured schedule. Additionally or alternatively, modeling dataset module 114 can generate the modeling dataset in response to an input. For example, a user of lead conversion service 108 can use their client device 102 and issue a request to generate a modeling dataset. In some cases, the request may indicate an amount of historical lead conversion data to use in generating the modeling dataset. In response, modeling dataset module 114 can retrieve the historical lead conversion data for generating the modeling dataset from data repository 112 and generate the modeling dataset using the retrieved historical lead conversion data. Modeling dataset module 114 can store the generated modeling dataset within data repository 112, where it can subsequently be retrieved and used (e.g., retrieved and used to build an ML classification model for predicting a likelihood of a lead conversion).

Still referring to lead conversion service 108, lead conversion module 116 is operable to predict a likelihood of a lead conversion. In other words, lead conversion module 116 is operable to predict, for an input of information about a lead (e.g., a new lead), a likelihood of the lead converting to a sales opportunity. In some embodiments, lead conversion module 116 can include a decision tree-based algorithm, such as a random forest, trained for classification using a modeling dataset generated from the organization's multi-dimensional historical lead conversion data. The modeling dataset may be retrieved from data repository 112. The random forest is a supervised learning algorithm that builds (e.g., constructs) an ensemble of decision trees (e.g., classification decision trees). The decision trees may be trained using bagging (also known as bootstrap aggregation). Bagging is a parallel ensemble method that trains the individual decision trees are trained on a subset of the modeling dataset (e.g., the individual decision trees are trained on different data samples and different features). Each decision tree is trained independently and generates a prediction. The final prediction (e.g., output) of the random forest classifier is based on aggregating the predictions of the individual decision trees. For example, the final prediction from the random forest classifier may be based on majority voting after combining the predictions of all decision trees.

In one embodiment, as can be seen in FIG. 1B, the random forest classifier of lead conversion module 116 can include classifiers 124a, 124b, . . . , 124n (individually referred to herein as classifier 124 or collectively referred to herein as classifiers 124) and a results aggregator 126. In the example of FIG. 1B, each classifier 124 may correspond to a decision tree. Each classifier 124 (i.e., decision tree) may be constructed using different data samples and different features from the modelling dataset, which reduces the bias and variance. In a training process, classifiers 124 can be constructed using a portion of the modeling dataset (e.g., approximately 70% of the modeling dataset). In a testing process, the constructed classifiers 124 can be validated using the remaining portion of the modeling dataset (e.g., the portion of the modeling dataset not used in the training process). Hyperparameter tuning may be performed to adjust the number of classifiers 124 constructed in the random forest classifier. To make a prediction for a new lead, the new lead runs through the different classifiers 124 of the random forest classifier, and each classifier 124 generates a prediction (e.g., each classifier 124 outputs a prediction of a likelihood of the new lead converting to a sales opportunity). Results aggregator 126 is operable generate a final prediction by aggregating the predictions from the individual classifiers 124. For example, results aggregator 126 can output the prediction made by the majority of the different classifiers 124 as the final prediction (e.g., Yes=new lead will be converted or No=new lead will not be converted).

Service interface module 118 is operable to provide an interface to lead conversion service 108. For example, in one embodiment, service interface module 118 may include an API that can be utilized, for example, by client applications to communicate with lead conversion service 108. For example, a client application, such as a lead conversion service client application or a web client, on a client device (e.g., client device 102 of FIG. 1A) can send requests (or “messages”) to lead conversion service 108 wherein the requests are received and processed by service interface module 118. Likewise, lead conversion service 108 can utilize service interface module 118 to send responses/messages to the client application on the client device.

In some embodiments, service interface module 118 may include user interface (UI) controls/elements which may be presented on a UI of the client application on the client device and utilized to access lead conversion service 108. For example, a user can click/tap/interact with the presented UI controls/elements to specify information (e.g., details) about a new lead and send a request for a lead conversion determination. In response to the user's input, the client application on the client device may send a request to lead conversion service 108 for a prediction of a likelihood of conversion of the new lead to a sales opportunity. In response to the request from the client application, lead conversion service 108 can utilize lead conversion module 116 to predict a likelihood of the new lead converting to a sales opportunity. Lead conversion service 108 can then send the prediction (e.g., prediction of the likelihood of a lead conversion) to the client application for presenting to the user of the client application, for example. As another example, a user can click/tap/interact with the presented UI controls/elements to issue a request to collect historical lead conversion data. The user may use a presented UI control/element to specify a period for the historical lead conversion data which is to be collected (e.g., collect lead conversion data for historical leads from a specified period such as from the preceding six months, 12 months, 24 months, or any other specified period). In response to the user's input, the client application on the client device may send a request to lead conversion service 108 to collect historical lead conversion data for leads from the specified period. In response to the request from the client application, lead conversion service 108 can utilize data collection module 110 to collect the historical lead conversion data. As still another example, a user can click/tap/interact with the presented UI controls/elements to issue a request to generate a modeling dataset and specify an amount of historical lead conversion data to use in generating the modeling dataset. In response to the user's input, the client application on the client device may send a request to lead conversion service 108 to generate a modeling dataset. In response to the request from the client application, lead conversion service 108 can utilize modeling dataset module 114 to generate a modeling dataset. Generally, the presented UI controls/elements can be used to interact with lead conversion service 108 (e.g., send requests to and receive responses from lead conversion service 108).

Referring now to FIG. 2 and with continued reference to FIGS. 1A and 1B, shown is a diagram illustrating a portion of a data structure 200 that can be used to store information about relevant features of a modeling dataset for training a machine learning (ML) model to predict a likelihood of a lead conversion, in accordance with an embodiment of the present disclosure. For example, the modeling dataset including the illustrated features, including other features generated from the organization's historical lead conversion data may be used to train an ML classification model (e.g., a random forest) to predict a likelihood of a lead conversion. As can be seen in FIG. 2, data structure 200 may be in a tabular format in which the structured columns represent the different relevant features (variables) regarding the historical lead conversion data of the organization and a row represents individual historical leads. The relevant features illustrated in data structure 200 are merely examples of features that may be extracted from the historical lead conversion data and used to generate a modeling dataset and should not be construed to limit the embodiments described herein.

As shown in FIG. 2, the relevant features may include a customer/account 202, a lead contact 204, a lead owner 206, a lead source 208, a region 210, a campaign type 212, a solution type 214, a product focus 216, and a lead converted 220. Customer/account 202 indicates a customer or potential customer associated with the historical lead. Lead contact 204 indicates a person or a team that represented the customer or potential customer and was responsible for the historical lead (e.g., person or team to contact at the customer or potential customer about converting the lead). For example, the indicated person or team may have been the potential buyer/purchaser of the product and/or service. Lead owner 206 indicates a person associated with the organization who was responsible for the historical lead. For example, the indicated person may be a member of the organization's marketing team who was responsible for or tasked with converting the historical lead. Lead source 208 indicates a source of the historical lead (e.g., indicates how the lead originated, was obtained, etc.). For example, lead source 208 may indicate that the historical lead originated through a partner (e.g., a channel partner) of the organization. As another example, lead source 208 may indicate that the historical lead originated via the organization's web site (e.g., the potential customer visiting the organization's website).

Region 210 indicates the geographical region (e.g., Asia, Pacific, and Japan (APJ), North and South America (AMER), Europe, Middle East, and Africa (EMEA), etc.) to which the customer or potential customer belongs (e.g., a geographical region in which the organization is doing business and to which the customer or potential customer belongs). Campaign type 212 indicates a type of marketing campaign (e.g., “digital marketing”, “tele sales”, “client marketing”, etc.) associated with the historical lead. For example, the historical lead may have been generated (e.g., sourced) using a marketing campaign conducted by the organization. In this case, campaign type 212 indicates the type of marketing campaign used to generate the historical lead. Solution type 214 indicates a type of product line (or “product family”) associate with the historical lead. The type of product line, for example, may be a group of related products and/or services produced and/or sold by the organization under a same brand (e.g., “core client”, “workstations”, “servers”, etc.). The organization may create product lines to leverage the loyalty of existing customers toward its original brand(s). Solution type 214 may indicate the product line associated with the product/service that is of interest to customer or the potential customer (e.g., the product line associated with the product/service the customer or potential customer is inquiring about). Product focus 216 indicates the product and/or service (e.g., “notebooks”, “smart phones”, “servers”, “desktops”, “gateways”, etc.) that is the focus of the historical lead (e.g., the primary product the customer or potential customer is interested in or inquiring about). Lead converted 220 indicates whether the historical lead was converted to a sales opportunity (e.g., “1=Yes”) or was not converted to a sales opportunity (e.g., “0=No”). Lead converted 220 is the label added to the historical lead.

In data structure 200, each row may represent a training/testing/validation sample (i.e., an instance of a training/testing/validation sample) in the modeling dataset, and each column may show a different relevant feature of the training/testing sample. In some embodiments, the individual training/testing samples may be used to generate a feature vector, which is a multi-dimensional vector of elements or components that represent the features in a training/testing sample. In such embodiments, the generated feature vectors may be used for training/testing an ML classification model (e.g., a random forest of lead conversion module 116) to predict a likelihood of a lead conversion for a new lead. The features customer/account 202, lead contact 204, lead owner 206, lead source 208, region 210, campaign type 212, solution type 214, and product focus 216 may be included in a training/testing sample as the independent variables, and the lead converted 220 included as the dependent variable (target variable) in the training/testing sample. The illustrated independent variables are features that influence performance of the ML model (i.e., features that are relevant (or influential) in predicting a likelihood of a lead conversion).

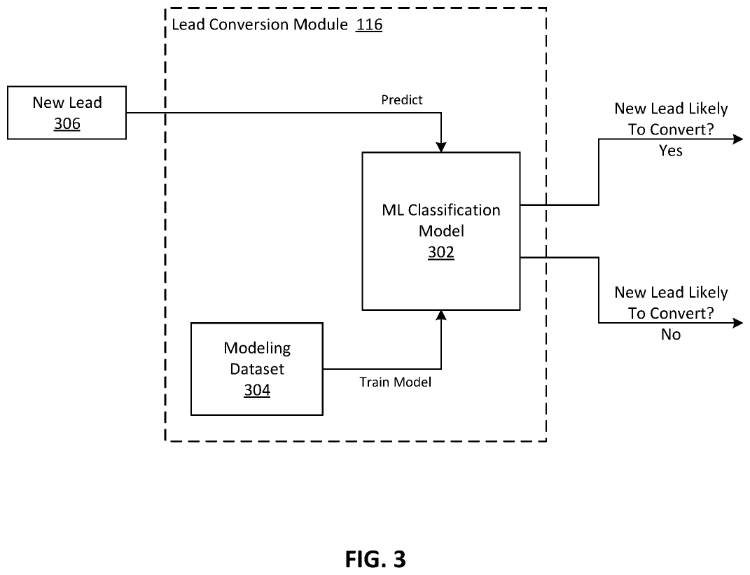

Referring now to FIG. 3, in which like elements of FIG. 1B are shown using like reference designators, shown is a diagram of an example topology that can be used to predict a likelihood of a lead conversion, in accordance with an embodiment of the present disclosure. As shown in FIG. 3, lead conversion module 116 includes a ML classification model 302. As described previously, according to one embodiment, ML classification model 302 may be a random forest. ML classification model 302 can be trained and tested using machine learning techniques with a modeling dataset 304. Modeling dataset 304 can be retrieved from a data repository (e.g., data repository 112 of FIG. 1B). As described previously, modeling dataset 304 for ML classification model 302 may be generated from the collected corpus of the organization's historical lead conversion data. Once ML classification model 302 is sufficiently trained, lead conversion module 116 can, in response to receiving information regarding a new lead, predict a likelihood of a lead conversion (e.g., predict a likelihood of the new lead converting to a sales opportunity). For example, as shown in FIG. 3, a feature vector 306 that represents a new lead, such as some or all the variables that may influence the prediction of a lead conversion, may be determined and input, passed, or otherwise provided to the trained ML classification model 302. In some embodiments, the input feature vector 306 (e.g., the feature vector representing the new lead) may include some or all the relevant features which were used in training ML classification model 302. The trained ML classification model 302 can then predict a likelihood of the new lead represented by feature vector 306 converting to a sales opportunity.

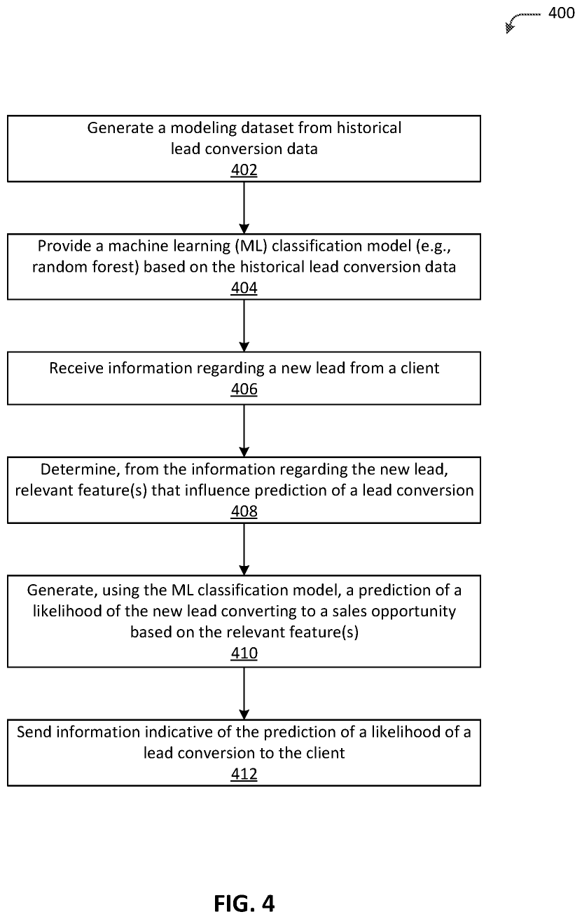

FIG. 4 is a flow diagram of an example process 400 for prediction of a likelihood of a lead conversion, in accordance with an embodiment of the present disclosure. Process 400 may be implemented or performed by any suitable hardware, or combination of hardware and software, including without limitation the components of network environment 100 shown and described with respect to FIGS. 1A and 1B, the computing device shown and described with respect to FIG. 5, or a combination thereof. For example, in some embodiments, the operations, functions, or actions illustrated in process 400 may be performed, for example, in whole or in part by data collection module 110, modeling dataset module 114, and lead conversion module 116, or any combination of these including other components of lead conversion service 108 described with respect to FIGS. 1A and 1B.

With reference to process 400 of FIG. 4, at 402, a modeling dataset for use in training an ML model may be generated from historical lead conversion data of an organization. For example, data collection module 110 may collect the historical lead conversion data from one or more data sources used by the organization to store or maintain such information/data and store the collected historical lead conversion data within data repository 112. Modeling dataset module 114 can then retrieve a corpus of historical lead conversion data from data repository 112, generate the modeling dataset, and store the modeling dataset within data repository 112.

At 404, an ML classification model trained or configured using the modeling dataset generated from some or all the collected historical lead conversion data may be provided. For example, a decision tree-based algorithm, or other suitable classification algorithm may be trained and tested using the modeling dataset (e.g., modeling dataset generated by modeling dataset module 114) to build the ML classification model. For example, in one implementation, modeling dataset module 114 may retrieve the modeling dataset from data repository 112 and use the modeling dataset to train a random forest for classification. The trained random forest (e.g., random forest classifier) can, in response to receiving information regarding a new lead, predict a likelihood of the new lead converting to a sales opportunity.

At 406, information regarding a new lead may be received. For example, the information regarding the new lead may be received along with a request for a lead conversion determination from a client (e.g., client device 102 of FIG. 1A). In response to the information regarding the new lead being received, at 408, relevant feature(s) that influence prediction of a lead conversion may be determined from the received information regarding the new lead. For example, in one implementation, lead conversion module 116 may determine the relevant feature(s) that influence prediction of a lead conversion.

At 410, a prediction of a likelihood of the lead converting to a sales opportunity may be generated. For example, lead conversion module 116 may generate a feature vector that represents the relevant feature(s) of the new lead. Lead conversion module 116 can then input the generated feature vector to the ML classification model (e.g., random forest classifier), which outputs a prediction of a likelihood of the new lead converting to a sales opportunity. The prediction generated using the ML classification model is based on the relevant feature(s) input to the ML classification model. The prediction by the ML classification model is based on the learned behaviors (or “trends”) in the modeling dataset used in training the ML classification model.

At 412, information indicative of the prediction of the likelihood of a lead conversion (e.g., “new lead likely to convert” or “new lead not likely to convert”) may be sent or otherwise provided to the client and presented to a user (e.g., the user who sent the request for a lead conversion determination). For example, the information indicative of the prediction may be presented within a user interface of a client application on the client. The user can then take appropriate action based on the provided prediction (e.g., prioritize or not prioritize the new lead for assignment to a marketing associate).

FIG. 5 is a block diagram illustrating selective components of an example computing device 500 in which various aspects of the disclosure may be implemented, in accordance with an embodiment of the present disclosure. As shown, computing device 500 includes one or more processors 502, a volatile memory 504 (e.g., random access memory (RAM)), a non-volatile memory 506, a user interface (UI) 508, one or more communications interfaces 510, and a communications bus 512.

Non-volatile memory 506 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 508 may include a graphical user interface (GUI) 514 (e.g., a touchscreen, a display, etc.) and one or more input/output (I/O) devices 516 (e.g., a mouse, a keyboard, a microphone, one or more speakers, one or more cameras, one or more biometric scanners, one or more environmental sensors, and one or more accelerometers, etc.).

Non-volatile memory 506 stores an operating system 518, one or more applications 520, and data 522 such that, for example, computer instructions of operating system 518 and/or applications 520 are executed by processor(s) 502 out of volatile memory 504. In one example, computer instructions of operating system 518 and/or applications 520 are executed by processor(s) 502 out of volatile memory 504 to perform all or part of the processes described herein (e.g., processes illustrated and described in reference to FIGS. 1A through 4). In some embodiments, volatile memory 504 may include one or more types of RAM and/or a cache memory that may offer a faster response time than a main memory. Data may be entered using an input device of GUI 514 or received from I/O device(s) 516. Various elements of computing device 500 may communicate via communications bus 512.

The illustrated computing device 500 is shown merely as an illustrative client device or server and may be implemented by any computing or processing environment with any type of machine or set of machines that may have suitable hardware and/or software capable of operating as described herein.

Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 502 may be analog, digital or mixed signal. In some embodiments, processor 502 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 510 may include one or more interfaces to enable computing device 500 to access a computer network such as a Local Area Network (LAN), a Wide Area Network (WAN), a Personal Area Network (PAN), or the Internet through a variety of wired and/or wireless connections, including cellular connections.

In described embodiments, computing device 500 may execute an application on behalf of a user of a client device. For example, computing device 500 may execute one or more virtual machines managed by a hypervisor. Each virtual machine may provide an execution session within which applications execute on behalf of a user or a client device, such as a hosted desktop session. Computing device 500 may also execute a terminal services session to provide a hosted desktop environment. Computing device 500 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, information regarding a new lead from another computing device;
determining, by the computing device, one or more relevant features from the information regarding the new lead, the one or more relevant features influencing prediction of a lead conversion;
generating, by the computing device using a machine learning (ML) model, a prediction of a likelihood of the new lead converting to a sales opportunity based on the determined one or more relevant features; and
sending, by the computing device, the prediction to the another computing device.

2. The method of claim 1, wherein the ML model includes an ML classification model.

3. The method of claim 2, wherein the ML classification model includes a plurality of classifiers.

4. The method of claim 2, wherein the ML classification model includes a random forest.

5. The method of claim 1, wherein the ML model is generated using a modeling dataset generated from a corpus of historical lead conversion data of an organization.

6. The method of claim 1, wherein the one or more relevant features includes a feature indicative of a customer associated with the new lead.

7. The method of claim 1, wherein the one or more relevant features includes a feature indicative of an individual responsible for the new lead.

8. The method of claim 1, wherein the one or more relevant features includes a feature indicative of a geographic region associated with the new lead.

9. The method of claim 1, wherein the one or more relevant features includes a feature indicative of a source that generated the new lead.

10. The method of claim 1, wherein the one or more relevant features includes a feature indicative of a product focus associated with the new lead.

11. The method of claim 1, wherein the information regarding the new lead is received from a remote computing device, and further wherein the sending the prediction is to the remote computing device.

12. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving information regarding a new lead from another computing device;
determining one or more relevant features from the information regarding the new lead, the one or more relevant features influencing prediction of a lead conversion;
generating, using a machine learning (ML) model, a prediction of a likelihood of the new lead converting to a sales opportunity based on the determined one or more relevant features; and
sending the prediction to the another computing device.

13. The computing device of claim 12, wherein the ML model includes an ML classification model.

14. The computing device of claim 13, wherein the ML classification model includes a plurality of classifiers.

15. The computing device of claim 13, wherein the ML classification model includes a random forest.

16. The computing device of claim 12, wherein the ML model is generated using a modeling dataset generated from a corpus of historical lead conversion data of an organization.

17. The computing device of claim 12, wherein the one or more relevant features includes a feature indicative of one of a customer associated with the new lead, an individual responsible for the new lead, a geographic region associated with the new lead, a source that generated the new lead, or a product focus associated with the new lead.

18. The computing device of claim 12, wherein the information regarding the new lead is received from a remote computing device, and further wherein the sending the prediction is to the remote computing device.

19. A non-transitory machine-readable medium encoding instructions that when executed by one or more processors cause a process to be carried out, the process including:
receiving information regarding a new lead from a computing device;
determining one or more relevant features from the information regarding the new lead, the one or more relevant features influencing prediction of a lead conversion;
generating, using a machine learning (ML) classification model, a prediction of a likelihood of the new lead converting to a sales opportunity based on the determined one or more relevant features; and
sending the prediction to the computing device.

20. The machine-readable medium of claim 19, wherein the ML classification model includes a random forest, wherein the random forest is trained using a modeling dataset generated from a corpus of historical lead conversion data of an organization.
